(19) United States
(12) Patent Application Publication
(10) Pub. No.: US 2005/0101176 A1
(43) Pub. Date: May 12, 2005

(54) Latch for electrical connector

(76) Inventor: Jerry D. Kachlic, Glen Ellyn, IL (US)

Correspondence Address: MOLEX INCORPORATED, 2222 WELLINGTON COURT, LISLE, IL, 60532, US

(21) Appl. No.: 10/705,769

(22) Filed: Nov. 10, 2003

(51) Int. Cl. H01R 13/627

(52) U.S. Cl. 439/352

(57) ABSTRACT

An electrical connector includes a housing formed of an insulative material, conductive terminals provided within the housing and a metal latch connected to the housing. The latch includes first and second legs which generally form a “V” shape. The first leg is attached to the housing. The second leg has protrusions for connecting the latch to a mating connector. The second leg is cantilevered relative to the first leg and is capable of being moved from an initial unstressed position to a stressed position towards the first leg when pressure is applied to the second leg and capable of returning to the initial unstressed position when the pressure is removed.

### BACKGROUND OF THE INVENTION

This invention is generally directed to a latch for an electrical connector which is used to mate the electrical connector to a mating connector.

Many electrical connectors include latches for securely, but releasably, retaining a pair of electrical connector housings in a mated condition. More particularly, these prior art connectors include mateable pairs of molded plastic housings, each of which is constructed to receive a plurality of terminals therein. The terminals of one housing electrically contact the terminals of the other housing when the housings are in their mated condition.

One such example of a prior art electrical connector with a latch is disclosed in U.S. Pat. No. 4,986,766 to Leonard et al. The electrical connector includes a housing and latch which are unitarily molded from plastic. Many electrical connectors are used in environments where they will be repeatedly connected and disconnected from the mating connector requiring that the latch have robustness to perform these repeated tasks. While the unitarily molded housing and latch provides certain manufacturing efficiencies, upon repeated actuation of the latch, the plastic latch has a tendency to break or lose elasticity such that the latch cannot return to the initial unbiased condition and insufficient engagement of the latch and the mating connector occurs.

Therefore, it is desirable to provide a latch which has robustness such that repeated matings can occur without detrimental wear on the latch. The present invention provides such a latch. Other features and advantages will become clear upon a reading of the attached specification in combination with a study of the drawings.

### OBJECTS AND SUMMARY OF THE INVENTION

A general object of the present invention is to provide a latch for an electrical connector which is used to mate the electrical connector to a mating connector.

An object of the present invention is to provide a robust latch for an electrical connector such that repeated matings can occur without detrimental wear on the latch.

Another object of the present invention is to provide a latch which provides a positive engagement with the mating connector and resists pull-out of the electrical connector from the mating connector.

Yet another object of the present invention is to provide a latch for an electrical connector which allows a user with relatively little familiarity with the mechanics and intended use of the electrical connector to be able to attach and detach the electrical connector to and from a mating connector.

A further object of the present invention to provide a latch that is low profile.

Briefly, and in accordance with the foregoing, the present invention discloses an electrical connector includes a housing formed of an insulative material, conductive terminals provided within the housing and a metal latch connected to the housing. The latch includes first and second legs which generally form a “V” shape. The first leg is attached to the housing. The second leg has locking protrusions for connecting the latch to a mating connector. The second leg is cantilevered relative to the first leg and is capable of being moved from an initial unstressed position to a stressed position towards the first leg when pressure is applied to the second leg and capable of returning to the initial unstressed position when the pressure is removed.

### BRIEF DESCRIPTION OF THE DRAWINGS

The organization and manner of the structure and operation of the invention, together with further objects and advantages thereof, may best be understood by reference to the following description, taken in connection with the accompanying drawings, wherein like reference numerals identify like elements in which:

FIG. 1 is a perspective view of a connector which incorporates the features of the invention and a perspective view of a mating connector;

FIG. 2 is a side elevational view of a latch which is provided on the connector shown in FIG. 1 and which incorporates the features of the invention;

FIG. 3 is a perspective view of the latch shown in FIG. 2; and

FIG. 4 is a top plan view of the latch shown in FIG. 2.

### DETAILED DESCRIPTION OF THE ILLUSTRATED EMBODIMENTS

While the invention may be susceptible to embodiment in different forms, there is shown in the drawings, and herein will be described in detail, a specific embodiment with the understanding that the present disclosure is to be considered an exemplification of the principles of the invention, and is not intended to limit the invention to that as illustrated and described herein.

An electrical connector 20 which incorporates the features of the present invention is shown in the drawings. The electrical connector mates with a mating connector 21. The electrical connector 20 includes a housing 22 having conductive terminals (not shown) mounted therein and a metal latch 24 mounted on the housing 22. The electrical connector 20 can be an input/output connector and can be used with a variety of electrical components such as a desktop personal computer, server and backup storage devices, digital video recorder, etc.

The housing 22 is formed from a non-conductive material, such as plastic, and may be molded as a single piece. The housing 22 is formed from a top wall, a bottom wall and a pair of side walls which connect the top wall and the bottom wall together. The top wall has a planar top surface 26. A forward mating end 28 is defined at the front of the housing walls and a rearward end 30 is defined at the back of the housing walls. A passageway (not shown) is formed within the housing 22 and extends from the forward mating end 28 to the rearward end 30.

The conductive terminals are mounted within the passageway by conventional means. Each terminal is formed in accordance with the prior art and includes a terminal engaging end for making electrical contact with a conductive lead, such as an individually insulated wire, a ribbon cable or the like, and a mating end for mating with the terminals in the mating connector 21.

A pair of latch retaining walls 32 extend perpendicularly outwardly from the top surface 26. The latch retaining walls 32 are spaced apart from each other a predetermined distance. Each latch retaining wall 32 is formed from a front wall 34 which is parallel to a front edge of the top wall of the housing 22, a side wall 36 which extends therefrom rearwardly towards the rearward end 30, and an anti-fishhook rib 38 which extends from the rearward end of the side wall 32. The side wall 36 is formed from a first section which tapers upwardly from the front wall 34 and a second section which has a top surface that is parallel to the top surface 26. The anti-fishhook rib 38 extends upwardly from the side wall 36 such that it has a height which is greater than the side wall 36. An anti-overstress arm 40, which is formed from a ledge, extends from the top of the anti-fishhook rib 38 towards the other latch retaining wall 32. The latch 24 sits between the latch retaining walls 32 and a portion 42 of the rear end of the latch 24 is positioned underneath the anti-overstress arms 40. The anti-fishhook ribs 38 and the anti-overstress arms 40 are known in the art and are disclosed in U.S. Pat. No. 4,986,766 which is commonly owned with the assignee herein. The anti-fishhook ribs 38 prevent the latch 24 from snagging or fishhooking conductive leads used in proximity to the housing 22. The anti-overstress arms 40 prevent over deflection of the latch 24 away from the top surface 26 of the housing 22. The side walls 36 define a height measured from the top surface 26 of the housing 22 which substantially corresponds to the undeflected height of the latch 24 and provide additional protection to the latch 24 from contact on the respective sides of the latch 24. As a result, the housing protects the latch 24 from over deflection away from the top surface 26 and from over deflection about an axis extending generally perpendicular to the top surface 26. Additionally, the side walls 36 provide further assurance that adjacent conductive leads or the like will not inadvertently become engaged intermediate the latch 24 and the top surface 26. Thus, the side walls 36 prevent overstress in the latch 24 and simultaneously prevent certain types of fishhooking beneath the latch 24.

The latch 24 is low profile and is formed of metal, preferably stainless steel. The latch 24 is formed of a first leg 44 and a second leg 46 which form a substantially “V” shape when viewed in side elevation as shown in FIG. 2. The first leg 44 is attached to the side walls 36 of the housing 22 and sits on top of the top surface 26 of the housing 22. The second leg 46 is spaced from and cantilevered relative to the first leg 44 and the top surface 26 of the housing 22. The second leg 46 extends generally away from the mating end 28 of the housing 22. The second leg 46 can be moved toward the first leg 44 when pressure is applied to an upper surface of the second leg 46. When the pressure is removed from the upper surface of the second leg 46, the metal has memory such that the second leg 46 will return to its initial, unbiased position.

The first leg 44 is planar and generally rectangular. Barbs 48 are provided on the side edges of the first leg 44. When the latch 24 is attached to the housing 22, the first leg 44 sits against the top surface 26 and the barbs 48 bite into the side walls 36. It is to be understood that other means for attaching the first leg 44 to the top surface 26 are within the scope of the invention.

The second leg 46 is generally rectangular and is angled relative to the first leg 44 and the top surface 26. As shown in the drawings, the second leg 46 includes a first portion 50, a second portion 52 and a third portion 54. The first portion 50 has an end attached to the forward end of the first leg 44 and is at a predetermined angle relative to the first leg 44 and the top surface 26 when the second leg 46 is in an unstressed position (when pressure is not applied to the second leg 46). A first end of the second portion 52 is connected to a second end of the first portion 50. The second portion 52 is at a predetermined angle relative to the first leg 44 and the top surface 26 when the second leg 46 is in the unstressed position. The predetermined angle at which the second portion 52 is provided is greater than the predetermined angle at which the first portion 50 is provided. A first end of the third portion 54 is connected to a second end of the second portion 52. The third portion 54 is substantially parallel to the first leg 44. It is to be understood that the second leg 46 can take other forms, provided that sufficient spacing is provided between the first and second legs 44, 46 such that the second leg 46 can be moved toward the first leg 44 by a user depressing the second leg 46 and can return to its initial, unbiased position when the pressure is removed.

A pair of spaced apart locking protrusions 56 extend from the second leg 46 in a direction opposite to that of the first leg 44. The locking protrusions 56 are provided on the first portion 50 of the second leg 46 and are equally spaced from the front edge of the second leg 46. The locking protrusions 56 extend generally perpendicularly relative to the first leg 44 and the top surface 26 of the housing 22. The rearward surface of the locking protrusions 56 are disposed along the second leg 46 at a location to engage locking apertures 58 in the mating connector 21 as described herein. If desired, the locking protrusions 56 can be formed with a ramped surface to provide for easier insertion and a rearward locking surface which is generally perpendicular to the first leg 44 and the top surface 26 of the housing 22.

The latch 24 is stamped and formed from a blank of metal. The shape is stamped; then bent at the intersection between the first leg 44 and the second leg 46; and then the locking protrusions 56 are bent outwardly from the second leg 46. Therefore, the construction of the latch 24 is very simple.

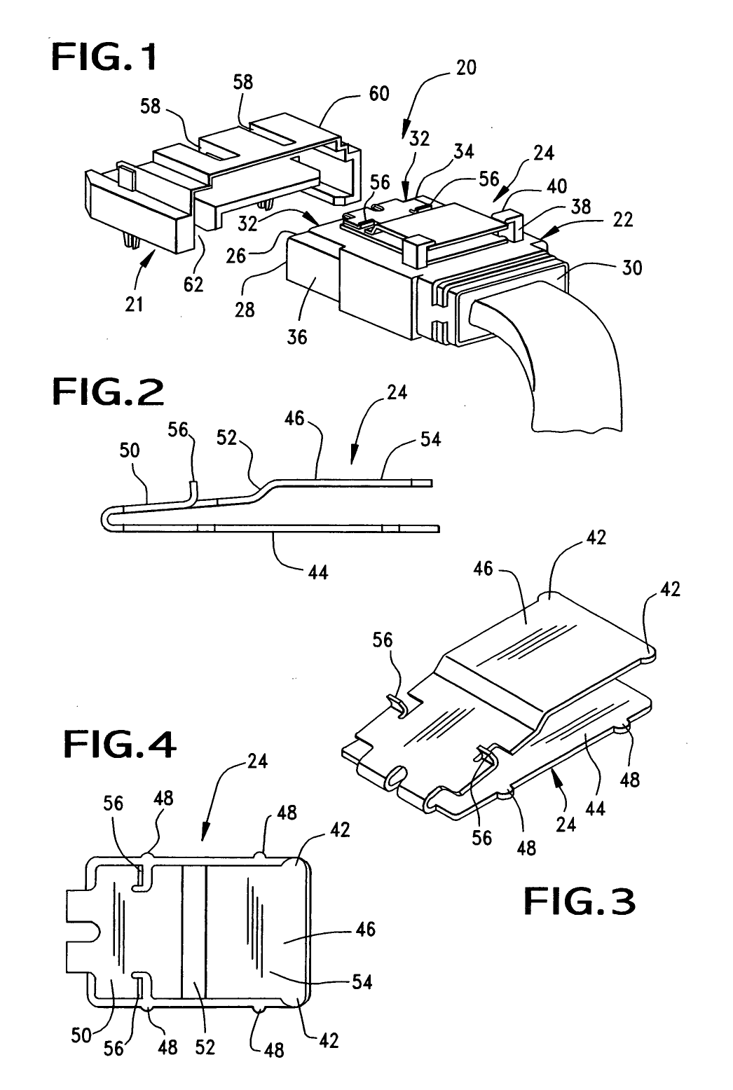

As shown in FIG. 1, the mating connector 21 is formed of a nonconductive housing 60, which may be formed from plastic, which has a passageway 62 extending from a mating end to an opposite end. A plurality of terminals are mounted within the passageway 62 by suitable means. Each terminal includes a conductor engaging end and an opposed mating end. The mating ends of the terminals in the mating connector 21 are engageable with the mating ends of the terminals in the electrical connector 20. The housing 60 is formed with a pair of locking apertures 58 which extend from the passageway through a top wall thereof. The locking apertures 58 are engageable with the locking protrusions 56 on the latch 24 as described herein.

When the electrical connector 20 is inserted into the mating connector 21, the locking protrusions 56 engage the wall which defines the upper surface of the passageway 62. As a result, the second leg 46 deflects towards the first leg 44 and the top surface 26 a sufficient distance to allow the continued insertion of the housing 22 of the electrical connector 20 into the housing 60 of the mating connector 21. Upon sufficient insertion of the housing 22 of the electrical connector 20 into the housing 60 of the mating connector 21, the locking protrusions 56 will align with the locking apertures 58 to permit the latch 24 to resiliently return to its unbiased condition. Thus, the rearward locking surfaces of the locking protrusions 56 engage the locking apertures 58 of the housing 60 to lockingly, but releaseably, hold the electrical connectors 20 and 21 in their mated condition.

In the mated condition, the third portion 54 of the second leg 46 extends outwardly from the electrical connector 20. The third portion 54 provides an actuator and a user can depress the second leg 46 toward the first leg 44 to release the engagement of the connectors 20 and 21. The third portion 54 is provided at a location which substantially corresponds to a position of maximum deflectability along the latch 24. As a result of this construction, a downward force applied to the third portion 54 urges the second leg 46 toward the first leg 44 and the top surface 26 of the housing 22 and will disengage the locking protrusions 56 from the locking apertures 58 in the housing 60 of the mating connector 21. Once the locking protrusions 56 are disengaged from the locking apertures 58, the electrical connector 20 can be removed from engagement with the mating connector 21 by pulling the electrical connector 20 outwardly from the mating connector 21. Because of its ease of use, the latch 24 allows a user with relatively little familiarity with the mechanics and intended use of the electrical connector 20 to be able to attach and detach the electrical connector 20 to and from the mating connector 21.

The locking protrusions 56 provide a positive engagement with the locking apertures 58 in the mating connector 21 which resists pull-out of the electrical connector 30 from the mating connector 21. Because the latch 24 is formed of metal, repeated depression of the latch 24 can be effected without significant wear and reduction in performance of the latch 24. In the prior art connectors which employ a plastic latch integrally formed with the plastic housing, such as the ones provided in U.S. Pat. Nos. 4,986,766, upon repeated depression of the latch, the latch has a tendency to break or lose elasticity such that the latch cannot return to the initial unbiased condition and insufficient engagement of the latch and the mating connector occurs.

In addition, the provision of two locking protrusions 56 provides several advantages over prior art latches that only employ a single locking protrusion. The provision of two locking protrusions 56 provides two points of retention with the mating connector 21; provides anti-rotation of the electrical connector 20 relative to the mating connector 21 around the centerline of the electrical connector 20; and provides redundancy if one locking protrusion 56 breaks.

While the locking apertures 58 are described as extending completely through the top 5 wall of the housing 60 of the mating connector 21, it is to be understood that other forms of retention in the mating connector 21 can be used. For example, indentations can be substituted for the locking apertures 58 provided that the indentations are deep enough to accommodate the respective locking protrusions 56. Alternatively, shoulders can extend inwardly from the upper wall that defines the passageway in the mating connector 21 such that the locking protrusions 56 engage behind the respective shoulders and the electrical connector 20 is prevented from disengaging from the mating connector 21 unless the latch 24 is depressed so that the locking protrusions 56 clear the shoulders.

In addition, since the latch 24 is not integral with the housing 22, the same housing 22 can be used regardless of whether a latch 24 is required to be used with the connector 20.

It is to be understood that the terms forward, rear and the like are used for purposes of explaining the connector of the present invention and are not intended to limit the scope of the invention.

While a preferred embodiment of the present invention is shown and described, it is envisioned that those skilled in the art may devise various modifications of the present invention without departing from the spirit and scope of the appended claims.

1. An electrical connector comprising:
a housing formed of an insulative material, the housing having a top surface;
conductive terminals provided within the housing;
a metal latch connected to the housing, the latch including a first leg and a second leg which is substantially angled relative to the first leg such that a substantially “V” shape is formed by the first and second legs, the first leg being attached to the housing, the second leg having means for connecting the latch to a mating connector, the second leg being cantilevered relative to the first leg and being capable of being moved from an initial unstressed position to a stressed position towards the first leg when pressure is applied to the second leg and capable of returning to the initial unstressed position when the pressure is removed.

2. An electrical connector as defined in claim 1, wherein the connecting means comprises at least one protrusion which extends from the second leg.

3. An electrical connector as defined in claim 2, wherein the at least one protrusion extends in a direction opposite to that of the first leg.

4. An electrical connector as defined in claim 2, wherein the first leg is planar and the second leg comprises a first portion, a second portion and a third portion, the first portion being angled relative to the first leg when the second leg is in the initial unstressed position and the third portion being substantially parallel to the first leg, the second portion connecting the first portion and the third portion together.

5. An electrical connector as defined in claim 4, wherein the at least one protrusion is provided on the first portion.

6. An electrical connector as defined in claim 2, wherein the first leg is planar and the second leg comprises a first portion, a second portion and a third portion, the first portion having an end attached to the first leg and being at a predetermined angle relative to the first leg when the second leg is in the initial unstressed position, a first end of the second portion being connected to a second end of the first portion, the second portion being at a predetermined angle relative to the first leg when the second leg is in the initial unstressed position which is greater than the predetermined angle of the first portion relative to the first leg, and a first end of the third portion being connected to a second end of the second portion, the third portion being substantially parallel to the first leg.

7. An electrical connector as defined in claim 6, wherein the at least one protrusion is provided on the first portion.

8. An electrical connector as defined in claim 1, wherein the connecting means comprises first and second spaced apart protrusions, the protrusions extending from the second leg.

9. An electrical connector as defined in claim 8, wherein the protrusions extend in a direction opposite to that of the first leg.

10. An electrical connector as defined in claim 8, wherein the first and second protrusions extend in a direction opposite to that of the first leg.

11. An electrical connector as defined in claim 8, wherein the first leg is planar and the second leg comprises a first portion, a second portion and a third portion, the first portion being angled relative to the first leg when the second leg is in the initial unstressed position and the third portion being substantially parallel to the first leg, the second portion connecting the first portion and the third portion together.

12. An electrical connector as defined in claim 11, wherein the first and second protrusions are provided on the first portion.

13. An electrical connector as defined in claim 8, wherein the first leg is planar and the second leg comprises a first portion, a second portion and a third portion, the first portion having an end attached to the first leg and being at a predetermined angle relative to the first leg when the second leg is in the initial unstressed position, a first end of the second portion being connected to a second end of the first portion, the second portion being at a predetermined angle relative to the first leg when the second leg is in the initial unstressed position which is greater than the predetermined angle of the first portion relative to the first leg, and a first end of the third portion being connected to a second end of the second portion, the third portion being substantially parallel to the first leg.

14. An electrical connector as defined in claim 13, wherein the first and second protrusions are provided on the first portion.

15. An electrical connector as defined in claim 1, wherein the top surface of the housing is substantially planar and the first leg is substantially parallel to the substantially planar top surface.

16. An electrical connector as defined in claim 1, wherein the first leg includes means for attaching the latch to the housing.

17. An electrical connector as defined in claim 16, wherein the housing has a pair of walls extending from the top surface, the first leg being positioned between the walls, the attaching means comprising barbs provided on the first leg which engage with the walls.

18. An electrical connector as defined in claim 1, wherein the metal latch is formed from stainless steel.
